(19) United States
(12) Patent Application Publication
(10) Pub. No.: US 2004/0004835 A1
(43) Pub. Date: Jan. 8, 2004

(54) LED structure in lamp type

(76) Inventor: Cheng-Hung Tsai, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,371

(22) Filed: Jul. 8, 2002

(51) Int. Cl. F21V 9/00

(52) U.S. Cl. 362/231; 362/235; 362/267; 362/800

(57) ABSTRACT

An LED structure in a LAMP type is directed to forming a columnar main body on a sealant. Inside of the columnar main body, it includes a light emitting member with two or more pins protruding out from inside. The characteristic is that a bottom portion inside the sealant has a circuit board. The circuit board has at least two chips, so as to emit an astonishing color light.

### BACKGROUND OF INVENTION

1. Field of Invention

The present invention relates to an led structure in a lamp type. More particularly, the present invention relates to a design that a control circuit is integrated with the LED under a lamp type, so that the device volume is reduced, the structure strength is improved, and application is more convenient. This indeed is a device with good design.

2. Description of Related Art

The conventional LED in lamp type usually is applied to a lamp decoration on an advertising board. For example, on the advertising board panel in good alignment, such as the line, circular, or planar form, by a timing control on the lamp for on/off and the different color of LED being turned on at the proper time, various words, patterns can be arranged for display. Moreover, due to the LED with the monochroic color light, many astonishing effect viewed by eye can be design out.

The conventional LED structure is shown in FIG. 6. It includes a columnar-like lamp formed by sealant 50. Inside the sealant 50, it has two electrode plates 60, 61 opposite to each other. The two electrode plates 60, 61 for the legs downward and transpire the sealant 50 for connecting with the power. However, if it is intended to achieve the blinking lamp with the advertising effect as described above, this kind of LED should be soldered on the circuit board and the a control box is used to adjust the timing of on/off for the blinking light. However, since so many of the LED's are soldered on the circuit board, the rework on them is tedious. In addition, it should also includes a control box, the volume would be rather large. This will cause inconvenient. Further still, since the soldering points are too many, it would occur in higher probability that the soldering contact points are easily broken. As a result, the fabrication yield is low. This is the disadvantage in the prior art.

The inventor has been involved in the art for a long period of time and recognizes that the bottleneck. According to the rich experiences and several experiments, an LED structure with smaller volume and better strength.

### SUMMARY OF INVENTION

One of the objectives in the invention is to form a columnar lamp body by sealant.

A circuit board is included at the bottom of the sealant. The circuit board includes at least one light emitting chip or an electronic part, such as integrated circuit. By using the foregoing assemblies, a blinking light source can be produced. At the same time, the volume can be effectively reduced.

Another objective of the invention is that the chip or the LED (SMD) element, which has been tested, is formed on the circuit board beforehand. Then, the sealant is used to form a lamp body. The light focusing effect can be improved. The use is also quite convenient. Wherein, the package in the form with the LED (SMD) can be tested about characteristics, such as wavelength, brightness, and so on, before actually taking the package, so that three primary colors of LED can be arranged in better matching effect. This can reduce some situations in poor matching effect due to, for example, the defect of the chip, the color and the electric property, when the package manner is directly packaging the chip.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a drawing of perspective view, schematically illustrating a structure, according to one embodiment of the invention;

FIG. 2 is a drawing of bottom view, schematically illustrating a structure, according to one embodiment of the invention;

FIG. 3 is a drawing of side view, schematically illustrating a structure, according to one embodiment of the invention;

FIGS. 4A-4C are drawings, schematically illustrating a structure, according to another embodiment of the invention;

FIGS. 5A-5C are drawings, schematically illustrating a structure, according to further another embodiment of the invention; and

FIG. 6 is a drawing, schematically illustrating a conventional structure.

### DETAILED DESCRIPTION

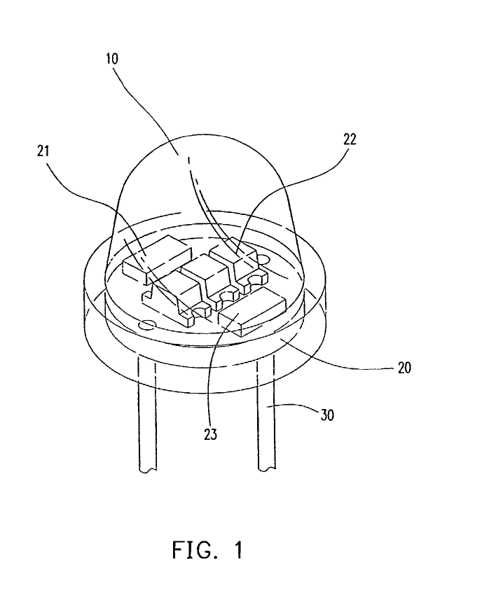

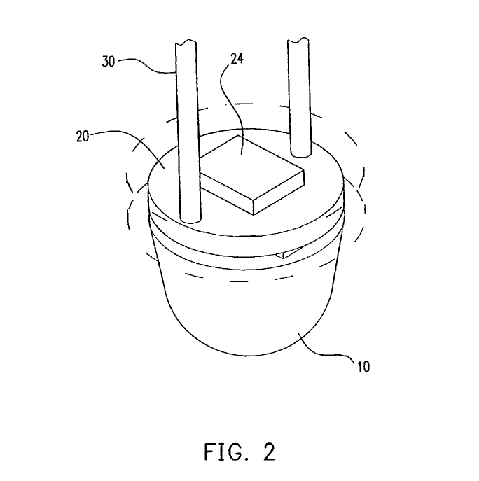

Referring to FIGS. 1 and 2, the LED of the invention includes a lamp body formed by a sealant 10. A circuit board 20 is implemented at the bottom of the sealant 10. The circuit board 20 has chips 22 in three colors of red, green, and blue, a capacitor 21, and a resister 23. The circuit board 20 is further implemented with a control IC 24 at the at the bottom surface, so as to control the blinking timing of the chip 22 and cause the chips 22 to emit the colorful light.

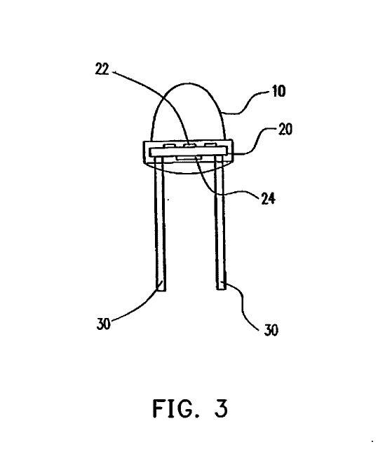

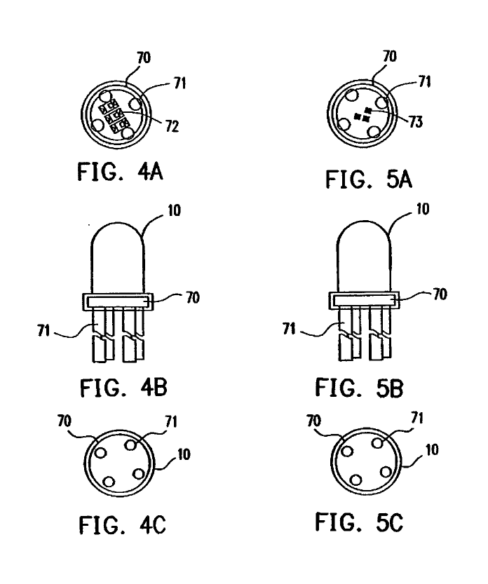

Referring to FIG. 3, in this embodiment, these light emitting diode chips 22 are controlled by the control IC 24 to blink the light. Two pins 30 are soldered on the circuit board 20 and are connected with the control IC 24. The pins 30 penetrate the sealant 1 0 and serve as the positive electrode and negative electrode for conduct.

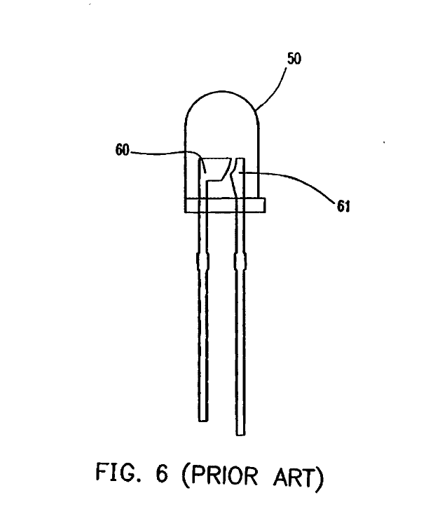

Referring to FIGS. 5 and 6, another embodiment of the invention is using the sealant to form a columnar lamp body. Thee chips 73 with respect to red, green, and blue or a SMD LED 72 are formed on upper side of the circuit board 70. The circuit board 70 is soldered with four pins 71, which penetrate through the sealant 10 and are, respectively, coupled to the positive electrodes and negative electrodes for the chips 73 or the SMD LED 72. Further still, the chips 73 or the SMD LED 72 are externally controlled by a control circuit or a controller, so as to control the blinking operation.

According to the invention, several advantages in operation are as follows:[

1. Since the LED of the invention is designed to be formed on the circuit board, the LED can be formed together with the other electronic part, such as chip, resister, capacitor, control IC, and so on, the fabrication can be performed in better systematic way. This can reduce many soldering works, and the fabrication time is reduced. In addition, product defect or failure can be greatly reduced. This is one of the main advantages of the invention.

2. Since the control circuit is integrated with the LED, the product volume can be effectively reduced. At the same time, since all of the elements are sealed in the sealant, the mechanical strength is improved. Further still, the control IC can directly control the internal parts. The use is in better convenient.

3. Since the chips formed on the circuit board includes three chips for each red, green, blue color. The chips can alternatively emit the lights, so that it includes three color light for one LED unit. The colorful blinking effect can be achieved.

4. Since the chips or the LED (SMD) formed on the circuit board are each with respect to red, green, and blue colors, wherein the package in the packaging manner of LED (SMD), so that the properties of wavelength, brightness, and so on, can be tested beforehand. The three colors can have the best match. This can prevent the product defect from occurring due to the malfunction of the chips when the chips are directly packaged, and resulting in the color and electric property not in match.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A light emitting device (LED) structure in a lamp type, wherein a columnar lamp body is formed by a sealant, the lamp body includes light emitting element parts, at least two pins penetrate out, the characteristic of the LED structure comprising:
a circuit board formed in the sealant, wherein the circuit board is implemented with at least two chips on a front surface or a back surface, so as to emit light.

2. The LED structure of claim 1, wherein the at least two chips on the circuit board include three chips for each of red, green, and blue colors, so that the three chips in single one of the LED structure can emit light in alternative manner or in together manner.

3. The LED structure of claim 1, wherein the circuit board is further implemented with a control IC, which is used to control a blinking timing for the chips.
